(19) United States
(12) Patent Application Publication
(10) Pub. No.: US 2024/0404715 A1
(43) Pub. Date: Dec. 5, 2024

(54) FUEL ASSEMBLY AND NUCLEAR REACTOR CORE

(71) Applicant: Hitachi, Ltd., Tokyo (JP)

(72) Inventors: Yuki NARUSHIMA, Tokyo (JP); Takeshi MITSUYASU, Tokyo (JP); Tetsushi HINO, Tokyo (JP)

(21) Appl. No.: 18/663,145

(22) Filed: May 14, 2024

(30) Foreign Application Priority Data
May 30, 2023 (JP) 2023-088813

(51) Int. Cl. G21C 3/328; G21C 3/332; G21C 5/16

(52) U.S. Cl. CPC G21C 3/328; G21C 3/332; G21C 5/16

(57) ABSTRACT

A fuel assembly includes: a square cylinder channel box having a square cross-section; and fuel rods disposed in a square lattice shape and filled with a nuclear fuel material. The fuel rods includes: a first rod disposed in an outer layer in the box and a second rod disposed in an inner layer in the box and having a larger diameter than the first rod. An absolute value of a difference between a hydraulic equivalent diameter around the first rod and a hydraulic equivalent diameter between a surface in the box and the first rod is more than or equal to a value obtained by multiplying an absolute value of a difference between the hydraulic equivalent diameter around the first rod and the hydraulic equivalent diameter around the second rod by a ratio of a cross-sectional area of the inner layer to a cross-sectional area of the entire box.

### CROSS-REFERENCE TO RELATED APPLICATION

The present application claims priority from Japanese application JP2023-088813, filed on May 30, 2023, the content of which is hereby incorporated by reference into this application.

### BACKGROUND

### Technical Field

The present invention relates to a fuel assembly and a nuclear reactor core, and particularly to a fuel assembly and a nuclear reactor core suitable for application to a boiling water reactor.

### Related Art

In order to effectively utilize uranium resources, reduce radioactive waste generation, and effectively utilize plutonium, a low-deceleration spectrum boiling water reactor is being developed on the basis of a light water reactor technology. The low-deceleration spectrum boiling water reactor has a core in which a plurality of fuel assemblies are disposed, each of the plurality of fuel assemblies being configured by disposing a plurality of fuel rods filled with a nuclear fuel material in a channel box of a square cylinder having a square cross section. In the fuel assembly, these fuel rods are densely disposed, and a ratio of water as a moderator in the channel box is greatly reduced. For this reason, in the fuel assembly loaded into the core of the low-deceleration spectrum boiling water reactor, fast neutrons generated by the nuclear fission of the fissionable material contained in each fuel material in the fuel rod are not decelerated so much, and neutrons having relatively high energy are used for the nuclear fission of the fissionable material.

JP 2020-118526 A discloses a fuel assembly loaded into a core of a low-deceleration spectrum boiling water reactor. In the fuel assembly, a plurality of fuel rods filled with MOX fuel are disposed in an equilateral triangular lattice, a pitch between the fuel rods is small, and an amount of water present inside is small. When a plurality of fuel rods are disposed in an equilateral triangular lattice in a channel box having a square cross section, a gap having a triangular cross section is formed near an inner surface of the channel box, and cooling water rising in the channel box easily rises through the gap. Therefore, the flow rate of the cooling water rising in the gap having a triangular cross section increases.

In the fuel assembly described in JP 2020-118526 A, a water removal rod attached to an inner surface of a channel box is disposed in each gap having a triangular cross section of the fuel assembly. This disposition of water removal bars further reduces the amount of water in the channel box. In such a fuel assembly loaded into the core of the low-deceleration spectrum boiling water reactor, the neutron spectrum is cured to improve the conversion rate of uranium 238 to plutonium 239, and the void reactivity coefficient can be further negative.

JP H4-198892 A proposes that in a case where 10 fuel rods are disposed in each of rows and columns, the diameter of one or two columns of fuel rods in the outer region A is smaller than the diameter of fuel rods in 5×5 (or 7×7) disposition of the inner region B in order to eliminate an increase in pressure loss. As a result, the pressure loss can be reduced and the local peaking can be flattened.

### SUMMARY

As in the fuel assembly disclosed in JP 2020-118526 A, in a fuel assembly loaded into a core of a low-deceleration spectrum boiling water reactor, a plurality of fuel rods are generally disposed in a regular triangular lattice shape in a channel box having a square cross section, and thus the fuel rods are densely disposed as compared with the conventional fuel assembly. Therefore, the hydraulic equivalent diameter decreases due to a decrease in the channel area and an increase in the wet edge length. When the hydraulic equivalent diameter decreases, the pressure loss of the fuel assembly increases, and it is necessary to increase the rotation speed of the pump of the nuclear reactor to allow the coolant to flow in.

The configuration proposed in JP 4-198892 A can reduce pressure loss and flatten local peaking, but the diameters of the fuel rods are different for small flow channels (subchannels) surrounded by the fuel rods and the wall surface, and thus the hydraulic equivalent diameters of the subchannels are distributed in the cross section of the fuel assembly. Therefore, it is conceivable that the flow rate distribution of the coolant is affected.

In consideration of the above circumstances, the inventors of the present invention have investigated that the disposition of the fuel rods in the rectangular cylindrical channel box of the fuel assembly is changed from an equilateral triangular lattice shape to a square lattice shape described in JP 2019-178896 A, and the fuel rods are densely disposed in order to cure the neutron spectrum during the operation of the nuclear reactor, as described in detail later. In this investigation, the inventors have confirmed that it is possible to reduce the pressure loss of the fuel assembly while maintaining the fuel inventory by disposing the fuel rod having a small diameter in the fuel rod disposed in each of the first and second layers from the outer layer of the channel box of the fuel rod array and disposing the fuel rod having a large diameter in the inner layer portion in the cross section of the fuel assembly as compared with the condition in which the same fuel rod diameter is used for all the fuel rods.

The ability to maintain the fuel inventory can maintain the amount of plutonium that can be loaded and can satisfy the objectives of a low-deceleration spectrum boiling water reactor.

However, it has been found, by changing the diameter of the fuel rod, that the distribution of the hydraulic equivalent diameter of the subchannel is generated in the cross section of the fuel assembly at the same time, and thus the distribution of the coolant is generated in the cross section of the fuel assembly by the distribution of the hydraulic equivalent diameter.

Therefore, it is desired to achieve a fuel assembly capable of appropriately distributing the coolant in the cross section of the fuel assembly under the condition that the hydraulic equivalent diameter of the subchannel can be distributed in the cross section of the fuel assembly.

An object of the present invention is to provide a fuel assembly and a nuclear reactor core capable of appropriately distributing a coolant in a cross section of the fuel assembly under a condition that a hydraulic equivalent diameter of a subchannel can be distributed in the cross section of the fuel assembly.

In addition, the above and other objects of the present invention and the novel features of the present invention will be clarified by the description of the present specification and the accompanying drawings.

The fuel assembly of the present invention is a fuel assembly including a channel box that is a square cylinder having a square cross section, and a plurality of fuel rods disposed in a square lattice shape in the channel box, and filled with a nuclear fuel material inside.

The fuel assembly of the present invention includes: a plurality of fuel rods including a first fuel rod disposed in an outer layer portion in the channel box; and a second fuel rod that is disposed in an inner layer portion in the channel box and has a diameter larger than the first fuel rod.

Further, in the fuel assembly of the present invention, an absolute value of a difference between a hydraulic equivalent diameter around the first fuel rod and a hydraulic equivalent diameter between a wall surface in the channel box and the first fuel rod is more than or equal to a value obtained by multiplying an absolute value of a difference between the hydraulic equivalent diameter around the first fuel rod and a hydraulic equivalent diameter around the second fuel rod by a ratio of a cross-sectional area of the inner layer portion of the channel box to a cross-sectional area of the entire channel box.

The nuclear reactor core of the present invention is loaded with a plurality of the fuel assemblies of the present invention.

With the present invention, the diameter of the second fuel rod of the inner layer portion is larger than the diameter of the first fuel rod of the outer layer portion of the fuel assembly. Further, with the present invention, the absolute value of the difference between the hydraulic equivalent diameter of the region formed between the wall surface of the channel box and the first fuel rod and the hydraulic equivalent diameter around the first fuel rod is more than or equal to a value obtained by multiplying the absolute value of the difference between the hydraulic equivalent diameter around the first fuel rod and the hydraulic equivalent diameter around the second fuel rod by the ratio of the cross-sectional area of the inner layer portion of the channel box to the cross-sectional area of the entire channel box.

As a result, it is possible to suppress lateral flow of the coolant from the outer layer portion to the inner layer portion in the channel box, to suppress uneven distribution of the coolant, and to appropriately distribute the coolant in the cross section of the fuel assembly.

Problems, configurations, and effects other than those described above will be clarified by the following description of embodiments.

### BRIEF DESCRIPTION OF DRAWINGS

FIG. 1 is a cross-sectional view of a fuel assembly of Example 1;

FIG. 2 is a longitudinal sectional view taken along line II-II in FIG. 1;

FIG. 3 is a longitudinal sectional view of a low-deceleration spectrum boiling water nuclear power plant loaded with the fuel assembly illustrated in FIG. 1;

FIG. 4 is an enlarged view of the fuel assembly of Example 1 for describing the hydraulic equivalent diameter;

FIG. 5 is a view illustrating a range of diameters of the fuel rods of the inner layer portion satisfied by the relational formula in the fuel assembly of Example 1;

FIG. 6 is a cross-sectional view of a fuel assembly of Example 2;

FIG. 7 is a cross-sectional view of a conventional fuel assembly; and

FIG. 8 is a cross-sectional view of the investigated fuel assembly.

### DETAILED DESCRIPTION

Hereinafter, embodiments and examples according to the present invention will be described with reference to texts or drawings. However, the structures, materials, other specific various configurations, and the like shown in the present invention are not limited to the embodiments and examples described herein, and can be appropriately combined and improved without changing the gist. In addition, elements not directly related to the present invention are not illustrated.

The inventors of the present invention have investigated suppression of lateral flow of a coolant to an inner layer portion in a fuel assembly in which a fuel rod disposition in a rectangular cylindrical channel box has a dense square lattice shape.

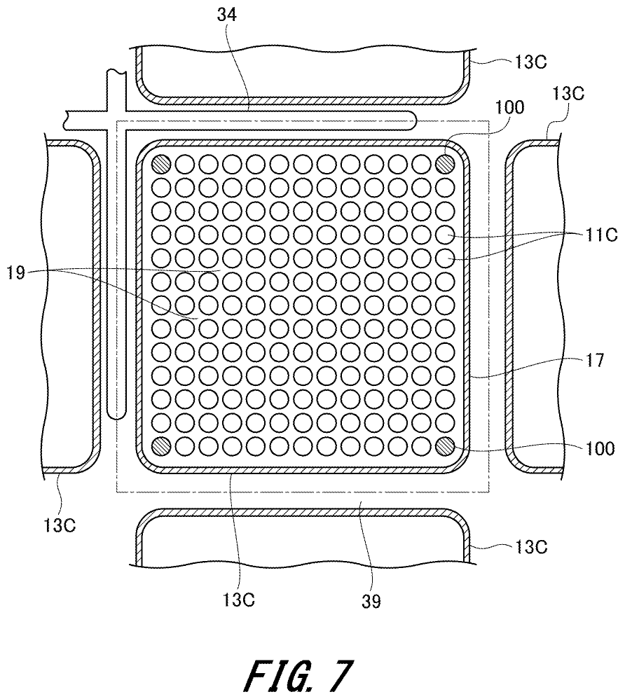

This investigation assumed a conventional fuel assembly in which a plurality of fuel rods are densely disposed in a square lattice shape in a channel box of a square cylinder having a square cross section. FIG. 7 is a cross-sectional view of the fuel assembly of the assumed conventional example.

Fuel assemblies 13C illustrated in FIG. 7 are loaded into a nuclear reactor core of a low-deceleration spectrum boiling water nuclear power plant. In each of the fuel assemblies 13C, a plurality of fuel rods 11C are disposed in 12 rows and 12 columns in a channel box 17 of a square cylinder having a square cross section. These fuel rods 11C are disposed in a square lattice shape.

As illustrated in FIG. 7, each of four support rods 100 is disposed at each of four corners of the outermost peripheral region (the first row from the inner surface of the channel box 17) of the fuel rod disposition in the cross section of each of the fuel assemblies 13C.

Each support rod 100 is desirably produced with a metal having a small neutron absorption cross section. The support rod 100 does not include nuclear fuel material. The lower end portion of the support rod 100 is screwed into the lower tie plate and attached to the lower tie plate. The upper end portion of the support rod 100 is inserted into a hole portion formed in the upper tie plate and held by the upper tie plate. Each support rod 100 plays a role of holding each fuel spacer at a predetermined position in the axial direction.

A water gap region 39 in which saturated water exists is formed between the fuel assemblies 13C loaded into the core. The water gap region 39 is present with facing each of the four side surfaces of the channel box 17 of the one fuel assembly 13C, that is, the outer surface of the channel box 17. A control rod 34 having a cross-shaped cross section is inserted into the water gap region 39 formed between the fuel assemblies 13C.

In the fuel assemblies 13C, a plurality of fuel rods 11C having a high enrichment degree of fissionable plutonium is disposed in the central portion of the cross section, and a plurality of other fuel rods 11C containing a burnable poison such as gadolinia is disposed in the outermost peripheral region. The fuel rod 11C containing the fissionable plutonium having a high enrichment degree is densely disposed in the central portion of the cross section, and thus the cooling water (light water) serving as a moderator is reduced, and the thermal neutron flux is small, that is, the neutron spectrum becomes hard.

On the other hand, in the outer peripheral portion of the fuel assembly 13C close to the water gap region 39 existing between the fuel assemblies 13C loaded in the core, the neutron spectrum becomes soft due to the influence of the cooling water in the water gap region 39. Therefore, the nuclear fission reaction of the fissionable plutonium becomes active in the outer peripheral portion of the cross section of the fuel assemblies 13C, increasing the power of each of the fuel rods 11C disposed in the first, second, and third rows from the inner surface of the channel box 17 in the fuel rod disposition. Such a state is continued throughout the operation cycle of the nuclear power plant.

In each of the fuel assemblies 13C, the fuel rods 11C are disposed in a dense square lattice shape, thus increasing the wet edge length of the fuel rods 11C and the channel box 17 in the flow path cross-sectional area of the fuel assembly 13C. Therefore, the fuel assemblies 13C have a feature that the hydraulic equivalent diameter of the fuel assembly 13C decreases and the pressure loss of the coolant flowing through the fuel assembly 13C increases.

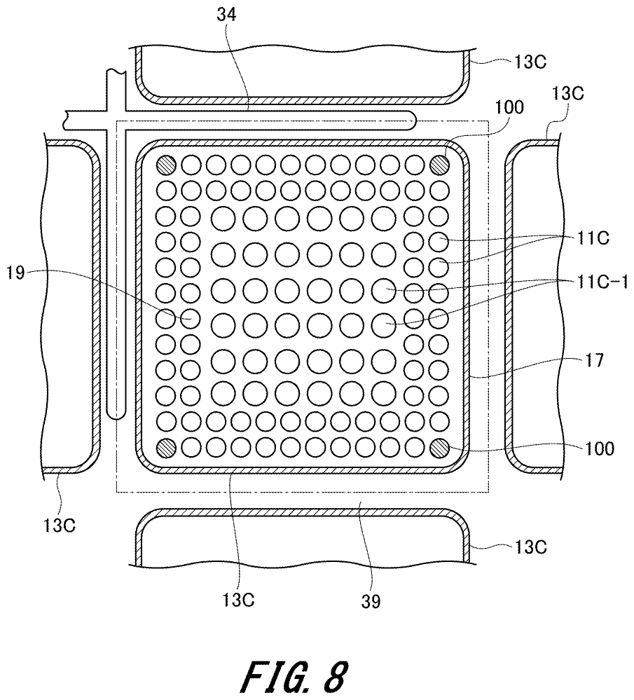

Therefore, the inventors of the present invention have attempted to reduce the pressure loss by reducing the area of the fuel rod while maintaining the fuel inventory. FIG. 8 illustrates a cross-sectional view of the fuel assembly 13C investigated at this time.

In the fuel assembly 13C illustrated in FIG. 8, a fuel rod 11C-1 having a large diameter is disposed in an inner layer portion of the fuel assembly 13C having a small power of the fuel rod. Increasing a diameter of the fuel rod reduces the number of lattices of the fuel rod in the inner layer portion. In the outer layer portion, the fuel rod pitch remains equivalent to 12×12. However, in the inner layer portion in which the fuel rod having a large diameter is disposed, when the fuel rods are disposed at a fuel rod pitch equivalent to 12×12, the interval between the fuel rods becomes extremely narrow, and thus, for example, the fuel rod pitch of 8×8 in the entire fuel assembly becomes the fuel rod pitch of the inner layer portion. As a result, the number of fuel rods in the inner layer portion is reduced, and thus the volume of the fuel rod is considered to be reduced, but the fuel inventory can be maintained by using a fuel rod having a large diameter as the fuel rod in the inner layer portion.

Further, when the thickness of the cladding on the surface of the fuel rod is constant, increasing the diameter of the fuel rod decreases the ratio of the cross-sectional area of the cladding to the cross-sectional area of the fuel rod. As a result, the flow path cross-sectional area can be increased by an amount corresponding to a decrease in the ratio of the cross-sectional area of the cladding while maintaining the fuel inventory, and the pressure loss can be reduced.

On the other hand, in the fuel assembly having the plurality of fuel rod diameters in which the fuel rod having a small diameter is used as the outer layer portion and the fuel rod having a large diameter is used as the inner layer portion, the hydraulic equivalent diameter of the subchannel has a distribution in the cross section of the fuel assembly. For example, in the outer layer portion, the diameter of the fuel rod is small and the fuel rods are densely disposed, and thus the hydraulic equivalent diameter becomes small. In the inner layer portion, the diameter of the fuel rod is large and the flow path area of the region surrounded by the fuel rod is large, and thus the hydraulic equivalent diameter is large.

The coolant of the fuel assembly tends to flow into a channel having a large hydraulic equivalent diameter and a low pressure loss. As a result, when a fuel rod having a small diameter is disposed in the outer layer portion and a fuel rod having a large diameter is disposed in the inner layer portion, the coolant is unevenly distributed in the inner layer portion because the hydraulic equivalent diameter of the inner layer portion is large.

The inventors of the present invention have investigated the measure to solve such a problem. As a result of the investigation, it has been found that for the hydraulic equivalent diameter 1 in the region formed between the first fuel rod and the channel box, the hydraulic equivalent diameter 2 around the first fuel rod, and the hydraulic equivalent diameter 3 around the second fuel rod in the fuel rod disposition in the cross section of the fuel assembly, the absolute value of the difference between the hydraulic equivalent diameter 1 and the hydraulic equivalent diameter 2 is more than or equal to a value obtained by multiplying the absolute value of the difference between the hydraulic equivalent diameter 2 and the hydraulic equivalent diameter 3 by the ratio of the flow path area of the inner layer portion to the entire flow path area, thereby allowing the uneven distribution of the coolant in the fuel assembly to be suppressed.

The fuel assembly of the present invention includes: a channel box that is a square cylinder having a square cross section, and a plurality of fuel rods disposed in a square lattice shape in the channel box, and filled with a nuclear fuel material inside, in which the plurality of fuel rods includes: a first fuel rod disposed in an outer layer portion in the channel box; and a second fuel rod that is disposed in an inner layer portion in the channel box and has a larger diameter than the first fuel rod.

Further, in the fuel assembly of the present invention, an absolute value of a difference between a hydraulic equivalent diameter around the first fuel rod and a hydraulic equivalent diameter between a wall surface in the channel box and the first fuel rod is more than or equal to a value obtained by multiplying an absolute value of a difference between the hydraulic equivalent diameter around the first fuel rod and a hydraulic equivalent diameter around the second fuel rod by a ratio of a cross-sectional area of the inner layer portion of the channel box to a cross-sectional area of the entire channel box.

That is, the fuel assembly of the present invention is defined by using the hydraulic equivalent diameter (hereinafter referred to as hydraulic equivalent diameter 1) in the region formed between the wall surface in the channel box and the first fuel rod, the hydraulic equivalent diameter (hereinafter, referred to as hydraulic equivalent diameter 2) around the first fuel rod, and the hydraulic equivalent diameter (hereinafter, referred to as hydraulic equivalent diameter 3) around the second fuel rod.

In the fuel assembly of the present invention, the absolute value of the difference between the hydraulic equivalent diameter 1 and the hydraulic equivalent diameter 2 is more than or equal to a value obtained by multiplying the absolute value of the difference between the hydraulic equivalent diameter 2 and the hydraulic equivalent diameter 3 by the ratio of the cross-sectional area of the inner layer portion of the channel box to the cross-sectional area of the entire channel box.

Specifically, the fuel assembly of the present invention satisfies the following relational formula.

$$\vert {D}_{h 1} - {D}_{h 2} \vert \geq {A}_{in} / A \times \vert {D}_{h 2} - {D}_{h 3} \vert \qquad ( 1 )$$

(Herein, Dₕ₁, Dₕ₂, and Dₕ₃ represent the hydraulic equivalent diameter 1, the hydraulic equivalent diameter 2, and the hydraulic equivalent diameter 3, respectively, and A and Aᵢₙ represent the entire cross-sectional area of the channel box and the cross-sectional area of the inner layer portion, respectively)

Because the diameter of the second fuel rod is larger than the diameter of the first fuel rod, for example, when the original number of grids is 12×12, the pitch of the fuel rod is still equivalent to 12×12 in the outer layer portion in which the small-diameter first fuel rod is disposed, but the pitch of the fuel rod is extremely narrowed when the fuel rod is disposed at the pitch of the fuel rod equivalent to 12×12 in the inner layer portion in which the large-diameter second fuel rod is disposed. Therefore, for example, the pitch of the fuel rod is the same as the pitch of the fuel rod when the pitch of the fuel rod is 8×8 in the entire fuel assembly. As a result, the number of fuel rods in the inner layer portion is reduced, and thus the volume of the fuel rod is considered to be reduced, but the fuel inventory can be maintained by using a fuel rod having a large diameter as the fuel rod in the inner layer portion.

Further, if the thickness of the cladding on the surface of the fuel rod is constant, the ratio of the cross-sectional area of the cladding to the cross-sectional area of the fuel rod decreases due to an increase in the diameter of the fuel rod. Therefore, it is possible to increase the flow path cross-sectional area by an amount corresponding to a decrease in the ratio of the cross-sectional area of the cladding while maintaining the fuel inventory, and it is possible to reduce the pressure loss.

On the other hand, in the fuel assembly having the plurality of fuel rod diameters in which the fuel rod having a small diameter is used as the outer layer portion and the fuel rod having a large diameter is used as the inner layer portion, the hydraulic equivalent diameter of the subchannel has a distribution in the cross section of the fuel assembly.

For example, in the outer layer portion, the diameter of the fuel rod is small and the fuel rods are densely disposed, and thus the hydraulic equivalent diameter becomes small. In contrast, in the inner layer portion, the diameter of the fuel rod is large and the flow path area of the region surrounded by the fuel rod is large, and thus the hydraulic equivalent diameter is large.

The coolant of the fuel assembly tends to flow into a channel having a large hydraulic equivalent diameter and a low pressure loss. As a result, when a fuel rod having a small diameter is disposed in the outer layer portion and a fuel rod having a large diameter is disposed in the inner layer portion, the coolant is unevenly distributed in the inner layer portion because the hydraulic equivalent diameter of the inner layer portion is large.

In a low-deceleration spectrum boiling water reactor, a region of water in a fuel assembly is eliminated as much as possible in order to maintain a spectrum. Therefore, a water rod or the like is not provided in the fuel assembly, and a large water region of the fuel assembly becomes a water gap between the fuel assemblies, and the powers of the outermost layer of the fuel assembly and the fuel rod one layer inside the outermost layer become the highest in the cross section of the fuel assembly.

On the other hand, if the fuel rod having a large diameter is disposed in the inner layer portion, the power of the fuel rod increases by the fuel volume increased by the increase in diameter, and thus, the powers of the outermost layer of the fuel assembly and the fuel rod one layer inside the outermost layer decrease by the increase in the power of the fuel rod having a large diameter in the inner layer.

However, even if the powers of the fuel rods of the outermost layer and one layer inside the outermost layer are relatively decreased due to the increase in the diameter of the fuel rod in the inner layer portion, the powers of the fuel rods of the outermost layer and the outer layer portion are still high, and thus uneven distribution of the coolant in the inner layer portion leads to a decrease in the thermal margin of the fuel rods of the outermost layer and one layer inside the outermost layer.

Assuming that the balance of the coolant between the outermost layer and one layer inside the outermost layer affects the hydraulic equivalent diameter, uneven distribution of the coolant can be suppressed by considering the difference in the hydraulic equivalent diameters. Therefore, minimizing the difference between the hydraulic equivalent diameter Dₕ₁ between the wall surface in the channel box and the first fuel rod, which is the hydraulic equivalent diameter of the outermost layer, and the hydraulic equivalent diameter Dₕ₂ around the first fuel rod, which is one layer inside, the coolant is evenly distributed.

On the other hand, assuming that the balance of the coolant from the outer layer portion to the inner layer portion affects the hydraulic equivalent diameter, uneven distribution of the coolant can be suppressed by considering the difference in the hydraulic equivalent diameters. Therefore, minimizing the difference between the hydraulic equivalent diameter Dₕ₂ around the first fuel rod, which is the hydraulic equivalent diameter of the outer layer portion, and the hydraulic equivalent diameter Dₕ₃ around the second fuel rod, which is the hydraulic equivalent diameter of the inner layer portion, the coolant is evenly distributed.

Herein, if the relationship of Dₕ₁<Dₕ₂ is satisfied, the flow of the coolant changes from the subchannel of the wall surface portion of the outermost layer to the subchannel of the outer layer portion, and from the subchannel of the outer layer portion to the subchannel of the inner layer portion. Therefore, it is necessary to suppress the flow of the coolant in order to suppress the uneven distribution of the coolant to the inner layer portion having a large diameter and to maintain the coolant of the subchannel of the outer layer portion.

If the amount of lateral flow from the wall surface portion to the outer layer portion is larger than the amount of lateral flow from the outer layer portion to the inner layer portion, a certain amount of the coolant exists in the outer layer portion. For this reason, the following relational formula is required.

$$\vert {D}_{h 1} - {D}_{h 2} \vert \geq \vert {D}_{h 2} - {D}_{h 3} \vert \qquad ( 2 )$$

The ratio of the inner layer portion to the all portions affects the total amount of lateral flow from the outer layer portion to the inner layer portion. Assuming that the outer layer portion in which the first fuel rod is disposed occupies most of the fuel rod disposed in the fuel assembly and the inner layer portion in which the second fuel rod is disposed is a significantly small portion, the amount of lateral flow from the outer layer portion to the inner layer portion that occupies the entire coolant amount is sufficiently small.

Conversely, if the inner layer portion in which the second fuel rod is disposed occupies most of the fuel rods disposed in the fuel assembly, the total amount of the coolant flowing laterally to the inner layer portion also increases.

Therefore, in order to consider the ratio of the region of the inner layer portion to the all portions, the entire cross-sectional area of the channel box and the cross-sectional area of the inner layer portion of the channel box are evaluated. Then, the influence of the ratio of the inner layer portion to the entire area can be considered by using the following formula, that is, the Formula (1), obtained by multiplying the right side of the above formula (2) by a value obtained by multiplying the ratio of the cross-sectional area Aᵢₙ of the inner layer portion of the channel box to the cross-sectional area A of the entire channel box.

$$\vert {D}_{h 1} - {D}_{h 2} \vert \geq {A}_{in} / A \times \vert {D}_{h 2} - {D}_{h 3} \vert \qquad ( 1 )$$

According to the Formula (1), it is possible to determine the relationship of the hydraulic equivalent diameter so as to prevent uneven distribution of the coolant to the inner layer portion for the lateral flow amount of the coolant from the outermost layer to the outer layer portion and from the outer layer portion to the inner layer portion while considering the ratio of the inner layer portion to the entire channel box.

Further, determining the fuel rod diameter so as to satisfy the hydraulic equivalent diameter can determine the fuel rod diameters of the first fuel rod and the second fuel rod so as to prevent uneven distribution of the coolant.

With the fuel assembly of the present invention, the diameter of the second fuel rod in the inner layer portion is larger than the diameter of the first fuel rod in the outer layer portion of the fuel assembly, and the absolute value of the difference between the hydraulic equivalent diameter of the region formed between the wall surface of the channel box and the first fuel rod and the hydraulic equivalent diameter around the first fuel rod is more than or equal to a value obtained by multiplying the absolute value of the difference between the hydraulic equivalent diameter around the first fuel rod and the hydraulic equivalent diameter around the second fuel rod by the ratio of the cross-sectional area of the inner layer portion of the channel box to the cross-sectional area of the entire channel box. That is, the Formula (1) is established.

As a result, it is possible to suppress lateral flow of the coolant from the outer layer portion to the inner layer portion in the channel box, to suppress uneven distribution of the coolant, and to appropriately distribute the coolant in the cross section of the fuel assembly. If the coolant is appropriately distributed in the cross section of the fuel assembly in this manner, it is possible to suppress a decrease in the critical thermal power of the fuel assembly and to maintain the thermal power during the operation of the nuclear power plant.

The fuel assembly can be configured such that a volume of a nuclear fuel material disposed in the fuel assembly is equal to or larger than a volume of a nuclear fuel material when the first fuel rods are disposed in a square lattice shape in the channel box.

With this configuration, the fuel inventory can be increased as compared with the configuration in which the volume of the nuclear fuel material disposed in the fuel assembly is less than the volume of the nuclear fuel material when the first fuel rod is disposed in a square lattice pattern in the channel box. This can facilitate maintaining a desired fuel inventory.

The fuel assembly can have a configuration in which a third fuel rod having a larger diameter than the second fuel rod is disposed in a further inner layer of a region in which the second fuel rod is disposed, and an absolute value of a difference between a hydraulic equivalent diameter around the second fuel rod and a hydraulic equivalent diameter between the first fuel rod and the second fuel rod is more than or equal to a value obtained by multiplying an absolute value of a difference between a hydraulic equivalent diameter around the third fuel rod and a hydraulic equivalent diameter around the second fuel rod by a ratio of a flow path area of a region in which the third fuel rod is disposed to a flow path area of a region in which the second fuel rod and the third fuel rod are disposed.

With this configuration, it is possible to suppress the coolant from being unevenly distributed from the region in which the second fuel rod is disposed to the region in which the third fuel rod is disposed in the cross section of the fuel assembly. In addition, the third fuel rod having a large diameter can increase the flow path area while maintaining the fuel volume, and thus the pressure loss can be further reduced.

The fuel assembly can have a configuration in which a lower end portion is supported by a lower fuel support member, an upper end portion is supported by an upper fuel support member, a fuel spacer that bundles the plurality of fuel rods is held, and a support rod without containing a fuel material is disposed at each of four corners of an outermost peripheral region of a fuel rod disposition in a cross section of the fuel assembly.

With this configuration, the power of the corner portion of the outermost layer of the fuel assembly is reduced by the support rod, and thus the amount of the coolant required for the corner portion of the outermost layer can be reduced, the diameter of the fuel rod can be determined such that the amount of the coolant to flow into the inner layer portion increases within a range satisfying the configuration of the present invention, and the critical thermal power of the fuel assembly can be expected to be improved.

### EXAMPLES

Hereinafter, specific examples of the fuel assembly will be described.

The examples of the present invention described below can be applied to a low-deceleration spectrum boiling water reactor which is a boiling water reactor. This low-deceleration spectrum boiling water reactor includes a low-deceleration spectrum boiling water reactor which is applied to: a boiling water reactor (BWR) in which cooling water is used as a coolant, the cooling water is flowed out of a nuclear reactor pressure vessel by a recirculation pump, and flowed into the reactor pressure vessel again for cooling water circulation; an advanced boiling water reactor (ABWR) having an internal pump and circulating cooling water inside a reactor pressure vessel; and high economic simplified boiling water nuclear reactor (ESBWR) without the internal pump in ABWR, and the like.

### Example 1

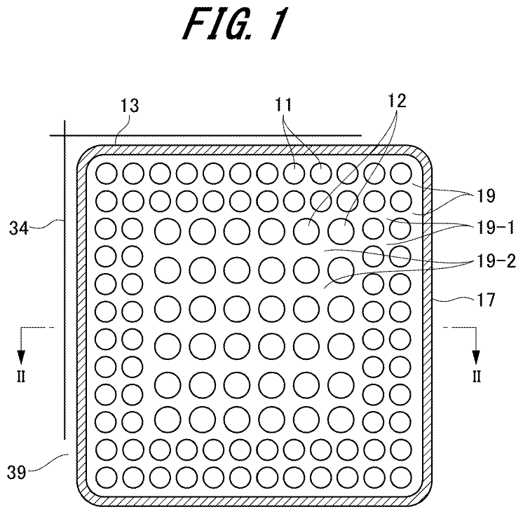

As a preferred example of the present invention, a fuel assembly of Example 1 used in a low-deceleration spectrum boiling water nuclear power plant will be described with reference to FIGS. 1 to 5.

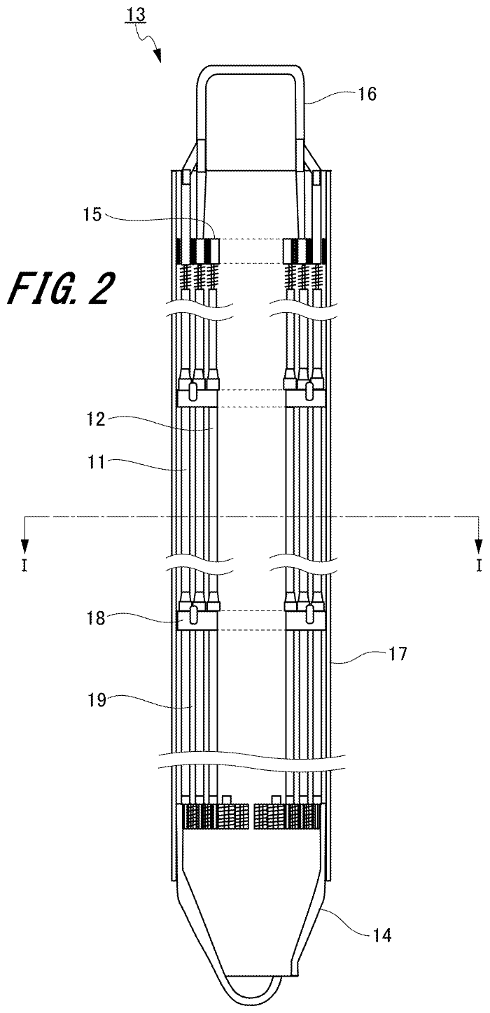

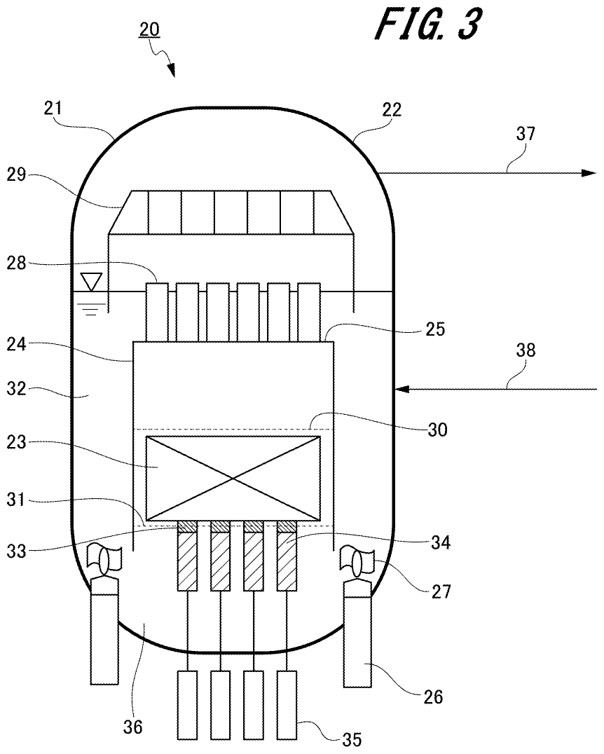

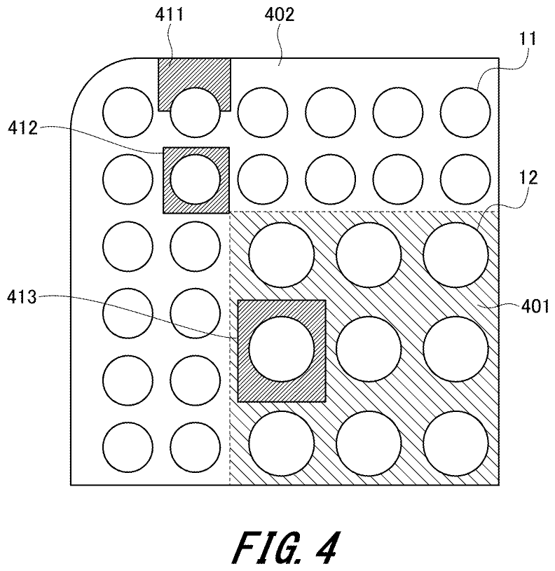

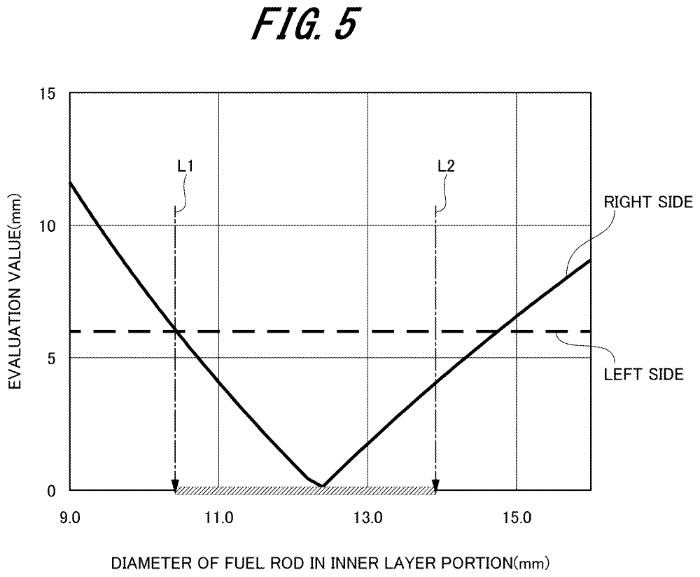

FIG. 1 is a cross-sectional view of a fuel assembly of Example 1. FIG. 2 is a longitudinal sectional view taken along line II-II in FIG. 1. FIG. 3 is a longitudinal sectional view of a low-deceleration spectrum boiling water nuclear power plant loaded with the fuel assembly illustrated in FIG. 1. FIG. 4 is an enlarged view of the fuel assembly of Example 1 for describing the hydraulic equivalent diameter. FIG. 5 is a view illustrating a range of diameters of the fuel rods of the inner layer portion satisfied by the relational formula in the fuel assembly of Example 1.

First, a structure of a nuclear reactor of a low-deceleration spectrum boiling water nuclear power plant loaded with the fuel assembly of the present example will be described with reference to FIG. 3.

A nuclear reactor 21 of this low-deceleration spectrum boiling water nuclear power plant 20 illustrated in FIG. 3 is an advanced boiling water reactor (ABWR).

This nuclear reactor 21 includes a nuclear reactor pressure vessel 22, and a core 23 loaded with a plurality of fuel assemblies (refer to the fuel assemblies 13 in FIGS. 1 and 2) is disposed in the nuclear reactor pressure vessel 22.

In the nuclear reactor pressure vessel 22, a cylindrical core shroud 24 surrounds the core 23, and a shroud head 25 disposed above the core 23 is installed at an upper end portion of the core shroud 24. A plurality of gas-water separators 28 are attached to the shroud head 25 and extend upward.

Further, a steam dryer 29 is installed in the nuclear reactor pressure vessel 22 above the gas-water separator 28. A downcomer 32 of an annular shape is formed between an outer surface of the core shroud 24 and an inner surface of the nuclear reactor pressure vessel 22.

An internal pump 26 disposed in the downcomer 32 extends downward through the bottom of the nuclear reactor pressure vessel 22 and is attached to the bottom of the nuclear reactor pressure vessel 22. The internal pump 26 has an impeller 27.

The main steam pipe 37 and the water supply pipe 38 are connected to the nuclear reactor pressure vessel 22.

An upper grid plate 30 is disposed above the core 23 and attached to an inner surface of the core shroud 24. A core support plate 31 is disposed below the core 23 and attached to an inner surface of the core shroud 24. A plurality of fuel support fittings 33 are installed on this core support plate 31.

A lower plenum 36 is formed below the core 23 in the nuclear reactor pressure vessel 22. A plurality of control rod guide pipes (not illustrated) are disposed in the lower plenum 36.

The control rods 34 each having a plurality of neutron absorbing rods filled with a neutron absorbing material (for example, boron carbide) and having a cross-shaped cross section are separately disposed in the respective control rod guide pipes. A plurality of control rod drive mechanisms 35 are installed at the bottom of the nuclear reactor pressure vessel 22 and extend downward from the bottom of the nuclear reactor pressure vessel 22, and each of the control rod drive mechanisms 35 is separately connected to the control rod 34.

As illustrated in FIG. 2, the fuel assembly 13 loaded into the core 23 includes a plurality of fuel rods 11 and 12, a lower tie plate (lower fuel support member) 14, an upper tie plate (upper fuel support member) 15, a plurality of fuel spacers 18 disposed in the axial direction, and a channel box 17.

The fuel assembly 13 is a MOX fuel assembly including a mixed oxide fuel (MOX fuel) of uranium oxide and plutonium oxide.

Each fuel rod 11 and each fuel rod 12 have a cladding (not illustrated), a lower end portion of the cladding is blocked with a lower end plug (not illustrated), and an upper end portion of the cladding is blocked with an upper end plug (not illustrated), and inside the cladding is filled with a plurality of fuel pellets (not illustrated) containing a nuclear fuel material (MOX fuel).

In addition, a gas plenum, which is not illustrated, is formed above the nuclear fuel material filling region filled with the fuel pellet in the cladding.

Lower end portions of each fuel rod 11 and each fuel rod 12 are supported by the lower tie plate 14, and upper end portions of each fuel rod 11 and each fuel rod 12 are supported by the upper tie plate 15. The upper tie plate 15 is provided with a handle 16.

Each fuel rod 11 and each fuel rod 12 are bundled by a plurality of fuel spacers 18 disposed at intervals in the axial direction. The bundled fuel rod 11 and fuel rod 12 are disposed in the channel box 17 in a state where the upper end portion is attached to the upper tie plate 15 and the rod extends downward.

As illustrated in the cross-sectional view of FIG. 1, the channel box 17 is a square cylinder having a square cross section.

The fuel rods 11 with 80 rods are disposed in 12 rows and 12 columns, and the fuel rods 12 with 36 rods are disposed in 6 rows and 6 columns in a square lattice pattern in the channel box 17.

The fuel rod 11 is disposed in an outer layer portion (outer layer portion) in the channel box 17 and corresponds to the first fuel rod described above.

The fuel rod 12 is disposed in an inner layer portion (inner layer portion) in the channel box 17 and corresponds to the second fuel rod described above.

The cooling water passage 19 is formed between the fuel rod 11 and the wall surface, the cooling water passage 19-1 is formed between the fuel rods 11, and the cooling water passage 19-2 is formed between the fuel rods 12.

In the present example, the diameter of the fuel rod 11, that is, the outer diameter of the cladding of the fuel rod 11 is 9 mm, and the diameter of the fuel rod 12, that is, the outer diameter of the cladding of the fuel rod 12 is 11 mm.

The lower tie plate 14 of the fuel assembly 13 loaded into the core 23 is supported by a fuel support fitting 33 installed on the core support plate 31. Each of the fuel support fittings 33 supports the lower tie plates 14 of the four fuel assemblies 13. The upper end portion of each channel box 17 of the four fuel assemblies 13 in which the lower tie plate 14 is supported by one fuel support fitting 33 is inserted into one grid formed in the upper grid plate 30. In the upper grid plate 30, a plurality of grids penetrating the upper grid plate 30 and having a square cross section are formed. Upper end portions of the four fuel assemblies 13 supported by the respective fuel support fittings 33 are inserted into corresponding grids, and each of the upper end portions is supported by the upper grid plate 30.

A water gap region 39 in which saturated water exists is formed between the fuel assemblies 13 loaded into the core 23 similarly to between the fuel assemblies 13C illustrated in FIG. 8. This water gap region 39 faces each of the four side surfaces of the channel box 17 of the one fuel assembly 13.

The control rod 34 connected to the control rod drive mechanism 35 is formed in a central portion of the fuel support fitting 33, and is inserted between the four fuel assemblies 13 supported by the fuel support fittings 33 through a control rod insertion hole (not illustrated) having a cross-shaped cross section penetrating the fuel support fitting 33. Insertion of the control rod 34 between the fuel assemblies 13 and extraction from the fuel assemblies 13 are each performed by the control rod drive mechanism 35. The control rod 34 inserted between the fuel assemblies 13 is present within the water gap region 39.

When the operation of the low-deceleration spectrum boiling water nuclear power plant 20 is started and the internal pump 26 is driven, the cooling water present in the downcomer 32 in the nuclear reactor pressure vessel 22 is pressurized by the impeller 27 of the internal pump 26.

The pressurized cooling water is supplied from the fuel support fitting 33 into the channel box 17 of the fuel assembly 13 through the lower plenum 36, and rises in the cooling water passage 19 formed between the fuel rods 11 in the channel box 17. During rising in the cooling water passage 19, the cooling water is heated by the heat generated by the nuclear fission of the fissionable material (for example, fissionable Pu) contained in the nuclear fuel material present in the fuel rod 11. A part of the heated cooling water becomes steam, and thus the cooling water becomes a gas-liquid two-phase flow containing water and steam.

This gas-liquid two-phase flow is discharged from the upper end of the fuel assembly 13, that is, from the core 23, and flows into the gas-water separator 28. In the gas-water separator 28, the gas-liquid two-phase flow is separated into water and steam.

The separated water is discharged from the gas-water separator 28 to the downcomer 32, descends in the downcomer 32 as cooling water, and is pressurized by the internal pump 26. In addition, the separated steam is guided from the gas-water separator 28 to the steam dryer 29, and the water contained in the steam is removed by the steam dryer 29.

The steam discharged from the steam dryer 29 from which the water has been removed is discharged from the nuclear reactor pressure vessel 22 to the main steam pipe 37, and is guided to a steam turbine (not illustrated) through the main steam pipe 37.

The steam rotates the steam turbine, which in turn rotates a generator (not illustrated) coupled to the steam turbine. Power is generated by the rotation of the generator.

Steam discharged from the steam turbine is condensed into water in a condenser (not illustrated). The condensed water is supplied to the nuclear reactor pressure vessel 22 by the water supply pipe 38 as water supply.

Herein, the disposition of the fuel rods 11 and 12 in the channel box 17 in the cross section of the fuel assembly 13 will be specifically described with reference to FIG. 1. The number of fuel rods 11 is 80, and the number of fuel rods 12 is 36.

A lower end portion of each of the fuel rod 11 and the fuel rod 12 is supported by the lower tie plate 14, and an upper end portion thereof is supported by the upper tie plate 15.

The axial length of the nuclear fuel material filling region in each of the fuel rod 11 and the fuel rod 12, that is, the fuel effective length is the same.

The disposition positions of the fuel rods 11 and 12 in the cross section of the fuel assembly 13 will be described.

The fuel rods 11 are disposed in the first and second rows from the inner surface of the channel box 17 in the fuel rod disposition in the cross section of the fuel assembly 13.

The fuel rods 12 are disposed in the third and subsequent rows from the inner surface of the channel box 17 in the fuel rod disposition in the cross section of the fuel assembly 13.

The fuel rods 11 and 12 disposed as described above are disposed so as to be point-symmetric about the center axis of the fuel assembly 13 in the cross section of the fuel assembly 13.

Then, a specific method for determining the diameters of the fuel rods of the fuel rods 11 and 12 by Formula (1) will be described.

First, a fuel rod diameter of the fuel rod 11 having a small diameter is determined. For example, in the present example, 9 mm is set with reference to the design of the fuel assembly of 12 rows and 12 columns. At this time, the center distance (fuel rod pitch) between the adjacent fuel rods is 11 mm.

The enlarged view of FIG. 4 illustrates an upper left ¼ region of the cross-sectional view of the fuel assembly 13 illustrated in FIG. 1, and illustrates each coolant passage (subchannel) necessary for the evaluation by Formula (1).

A subchannel 411 formed between the wall surface portion of the channel box and the fuel rod 11, and a subchannel 412 formed between the fuel rods 11 are used on the left side of Formula (1).

On the other hand, the subchannel 412 and a subchannel 413 formed between the fuel rods 12 are used on the right side of Formula (1). In the right side, the cross-sectional area of the channel box is further considered. Specifically, the entire cross-sectional area 402 of the channel box and the cross-sectional area 401 of the inner layer portion of the channel box are considered.

The relationship between the right side and the left side of Formula (1) at this time is illustrated in FIG. 5. In FIG. 5, the left side of Formula (1) is indicated by a broken line, and the right side of Formula (1) is indicated by a solid line. The vertical axis represents the evaluation values on the left side and the right side of Formula (1), and the horizontal axis represents the diameter of the fuel rod in the inner layer portion.

If the diameter of the fuel rod having a small diameter in the outer layer portion is constant, the value on the left side is not affected by the diameter of the fuel rod having a large diameter in the inner layer portion, and thus takes a constant value.

The fuel rod diameter at which the value on the left side indicated by the broken line is larger than the value on the right side indicated by the solid line is the diameter of the fuel rod in the inner layer portion at which the effect of the present invention can be expected. FIG. 5 illustrates a lower limit L1 of the diameter of the fuel rod in which the left side >the right side according to Formula (1) for evaluation.

On the other hand, FIG. 5 illustrates an upper limit L2 of the diameter of the fuel rod due to the fuel rod gap. In the present example, the pitch between the fuel rods in the inner layer portion is set to 14 mm.

As the fuel rod diameter of the inner layer portion approaches the pitch between the fuel rods, the distance between the fuel rods becomes extremely narrow, and thus, it is considered that the coolant is not sufficiently supplied to the gap and becomes locally thermally severe. Therefore, as one reference, the diameter of the fuel rod in the inner layer portion where the gap becomes 0 is illustrated in FIG. 5 as an upper limit L2 of the diameter of the fuel rod due to the fuel rod gap.

That is, the lower limit L1 of the fuel rod diameter of the inner layer portion is the fuel rod diameter in which the left side is equal to the right side in Formula (1), and the upper limit L2 of the fuel rod diameter of the inner layer portion is the upper limit due to the fuel rod gap.

In the present example, in consideration of reducing the pressure loss as much as possible while maintaining the fuel rod inventory, the diameter of the fuel rod in the inner layer portion is reduced, and the fuel rod diameter in the inner layer portion is set to 12 mm that satisfies Formula (1).

The flow path areas of the cooling water passages 19, 19-1, and 19-2 have a magnitude relationship of 19<19-1<19-2. Therefore, in the above described outermost layer portion in the cross section of the fuel assembly 13, the presence of the water gap region 39 softens the neutron spectrum and increases the fuel rod power.

In addition, in the outer layer portion excluding the outermost layer, a water region exists due to the cooling water passage 19-1 near the water gap region 39, thereby providing a fuel rod power equal to or more than that of the outermost layer.

On the other hand, in the inner layer portion, a water region exists due to the cooling water passage 19-2 and no water gap region exists, and thus it is considered that the neutron spectrum becomes hard and the fuel rod power decreases.

In the present example, it is confirmed by core performance calculation that the power of the fuel rod in the cross section of the fuel assembly is higher in the outermost layer and the outer layer portion than in the inner layer portion.

If the distribution is formed in the cooling water passages 19, 19-1, and 19-2 in the cross section of the fuel assembly, the hydraulic equivalent diameter of each cooling water passage is similarly distributed in the cross section of the fuel assembly. The coolant flowing through the fuel assembly flows unevenly in the cooling water passage having a low pressure loss, and the pressure loss is smaller for the cooling water passage having larger hydraulic equivalent diameter, and thus, it is considered that the coolant is unevenly distributed in the inner layer portion of the fuel assembly in which the fuel rod 12 having the cooling water passage 19-2 is disposed. Due to the uneven distribution of the coolant, there is a concern that the coolant amounts of the outermost layer portion and the outer layer portion, which originally have a high power of the fuel rod and require the coolant, are insufficient, and the critical thermal power is lowered.

The critical thermal power is a value that depends on the design of the fuel assembly, and is higher as the fuel assembly is better in terms of thermal hydraulics. It is necessary to determine the thermal power at the time of operation of the nuclear reactor so that the critical power ratio falls within the regulation value or less. That is, if a fuel rod having a high thermal load is present in the fuel assembly at the time of designing the fuel assembly, the critical thermal power of the fuel assembly decreases. As a result, in order to fall the critical power ratio within the regulation value or less, it is necessary to reduce the thermal power of the nuclear reactor during operation. This brings about an economic problem due to a decrease in the amount of power generated by the nuclear reactor, and a safety problem such as securing a sufficient operation margin.

The inventors of the present invention have obtained the coolant flow rate of each coolant passage in the cross section of the fuel assembly 13 of FIG. 1 described above by performance calculation of the fuel assembly. In the performance calculation of the fuel assembly, how the coolant is unevenly distributed in each coolant passage was evaluated by calculating the coolant amount per edge of the fuel rod in each coolant passage 19, 19-1, and 19-2. In the evaluation, for comparison, the coolant amount at the outlet of the fuel assembly of each of the coolant passages 19, 19-1, and 19-2 is normalized so that the average is 1.

The distribution of the coolant in the fuel assembly 13C illustrated in FIG. 7 when the present invention is not applied is 0.40 in the coolant passage 19, 0.31 in the coolant passage 19-1, and 0.29 in the coolant passage 19-2. In the fuel assemblies 13C illustrated in FIG. 7, the fuel rod having a large diameter is not disposed in the inner layer portion, and thus the coolant passage 19-2 has the same shape as the coolant passage 19-1.

In the fuel assemblies 13C illustrated in FIG. 7, a large amount of coolant is unevenly distributed in the outermost layer portion. In the fuel assemblies 13C illustrated in FIG. 7, the thermal power of the fuel rods of the outermost layer and the outer layer portion is increased, and thus it is preferable that a large amount of coolant is unevenly distributed in the outermost layer portion.

On the other hand, the distribution of the coolant in the fuel assembly 13 of the present example illustrated in FIG. 1 is 0.37 in the coolant passage 19, 0.28 in the coolant passage 19-1, and 0.34 in the coolant passage 19-2. In the fuel assembly 13 of the present example illustrated in FIG. 1, a fuel rod 12 having a large diameter is disposed in the inner layer portion, whereby the power of the fuel rod 12 in the inner layer portion increases, and the power of the fuel rods 11 in the outermost layer portion and the outer layer portion relatively decreases. Therefore, it is not necessary to distribute the coolant to each of the coolant passages 19, 19-1, and 19-2 equivalently to FIG. 7, and it is necessary to increase the coolant amount of the inner layer portion where the power increases.

In the fuel assembly 13 of FIG. 1, the coolant amount of the fuel of the inner layer portion is increased as compared with the fuel assemblies 13C of FIG. 7, and thus the cooling can be promoted against the increase in the fuel rod power of the inner layer portion.

In contrast, as a condition outside the range of Formula (1), the distribution of the coolant in the coolant passages 19, 19-1, and 19-2 when the fuel rod diameter of the inner layer portion is 10 mm is 0.28 in the coolant passage 19, 0.19 in the coolant passage 19-1, and 0.52 in the coolant passage 19-2. When the coolant amount of the coolant passage 19 is compared with the coolant amount of the coolant passage 19-2, the coolant amount of the coolant passage 19-2 is about 2 times the coolant amount of the coolant passage 19, but as described above, the fuel rod power is higher in the outermost layer and the outer layer portion. Therefore, if the fuel rod diameter of the inner layer portion does not satisfy Formula (1) of the present invention, the coolant amount is unevenly distributed, and the coolant cannot be sufficiently distributed to the fuel rod requiring the coolant.

With the present example, the fuel rods 11 having a small diameter are disposed in 12 rows and 12 columns inside the outermost layer and one layer inside the outermost layer of the fuel assembly, the fuel rods 12 having a large diameter are disposed in 6 rows and 6 columns in the inner layer portion, and the fuel rod diameter of the fuel rod 12 is determined so as to satisfy Formula (1). As a result, lateral flow of the coolant from the outer layer portion to the inner layer portion in the channel box 17 can be suppressed, and uneven distribution of the coolant in each coolant passage of the fuel assembly 13 can be suppressed. Suppressing the uneven distribution of the coolant in the fuel assembly 13 can suppress a decrease in the critical thermal power of the fuel assembly and maintain the thermal power during the operation of the low-deceleration spectrum boiling water nuclear power plant 20.

### Modification

In Example 1, there is not provided each of the four support rods 100 disposed at each of the four corners of the outermost peripheral region (the first row from the inner surface of the channel box 17) of the fuel rod disposition in the cross section of the fuel assemblies 13C illustrated in FIG. 7.

A modification to Example 1 can have a configuration in which each of the support rods having the same configuration as the support rod 100 of the fuel assemblies 13C of FIG. 7 is provided at each of the four corners of the outermost peripheral region of the fuel assembly 13 illustrated in FIG. 1.

The support rod reduces the power of the corner portion of the fuel assembly, and thus contributes to the flattening of the power distribution in the cross section of the fuel assembly. That is, installing the support rod at the corner portion can reduce the amount of coolant required at the corner portion of the outermost layer, can lead to determination of the diameter of the fuel rod so that the amount of coolant flowing into the inner layer portion increases within the range satisfying Formula (1), and the critical thermal power of the fuel assembly can be expected to increase.

### Example 2

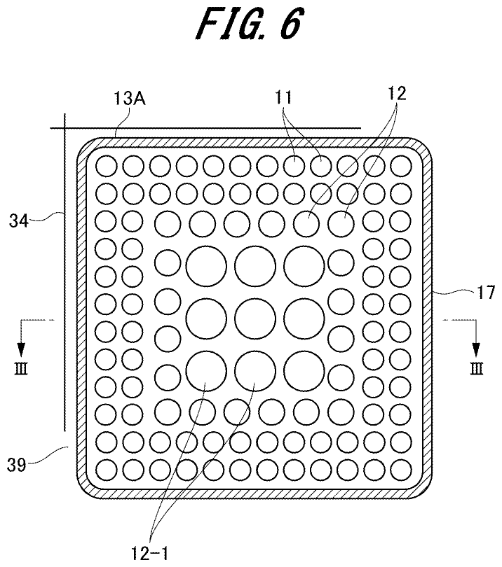

As another preferred example of the present invention, a fuel assembly of Example 2 used in a low-deceleration spectrum boiling water nuclear power plant will be described with reference to FIG. 6.

FIG. 6 is a cross-sectional view of a fuel assembly of Example 2.

In the fuel assembly 13A of the present example, the same components as those of the fuel assembly 13 of Example 1 illustrated in FIG. 1 are denoted by the same reference numerals.

The nuclear reactor 21 of the low-deceleration spectrum boiling water nuclear power plant 20 in which the fuel assembly 13A of the present example is loaded into the core is an advanced boiling water reactor (ABWR).

The disposition of the plurality of fuel rods 11, 12, and 12-1 in the channel box 17 in the cross section of the fuel assembly 13A of the present example will be specifically described with reference to FIG. 6.

The plurality of fuel rods 11 in the fuel assembly 13A are the same as the fuel rods 11 disposed in the fuel assembly 13 of Example 1. That is, the diameters of the fuel rods of the fuel rods 11 disposed in the fuel assembly 13A, the disposition of the fuel rods, and the number of the fuel rods are the same as those of the fuel rods 11 disposed in the fuel assembly 13 of Example 1.

The plurality of fuel rods 12 in the fuel assembly 13A are different from the fuel rods 12 disposed in the fuel assembly 13 of Example 1. That is, the diameter of the fuel rod of the fuel rod 12 disposed in the fuel assembly 13A is the same as the diameter of the fuel rod 12 disposed in the fuel assembly 13 of Example 1, but the disposition of the fuel rod and the number of the fuel rods are different from those of the fuel rod 12 disposed in the fuel assembly 13 of Example 1.

The fuel rods 12 disposed in the fuel assembly 13 of Example 1 are disposed in 6 rows and 6 columns. In contrast, the number of the fuel rods 12 disposed in the fuel assembly 13A of the present example is 6 rows and 6 columns, but the fuel rods 12 are not disposed in 4 rows and 4 columns of the inner layer portion, and the number of the fuel rods 12 is 20.

The plurality of the fuel rods 12-1 in the fuel assembly 13A are disposed in 3 rows and 3 columns in the layered portion on the inner side of the fuel rods 12, and the number of the fuel rods is 9. The diameter of the fuel rod 12-1 is larger than the diameter of the fuel rod 12.

The fuel rod 12-1 corresponds to the above-described third fuel rod.

The diameter of the fuel rod 12-1 is evaluated using Formula (1).

At this time, the hydraulic equivalent diameter of the coolant passage formed between the fuel rod 11 and the fuel rod 12 is represented by Dₕ₁ in Formula (1), the equivalent diameter around the fuel rod 12 is represented by Dₕ₂ in Formula (1), and the hydraulic equivalent diameter around the fuel rod 12-1 is represented by Dₕ₃ in Formula (1). In addition, the cross-sectional area of the region in which the fuel rod 12 and the fuel rod 12-1 are disposed is represented by A in Formula (1), and the cross-sectional area of the region in which the fuel rod 12-1 is disposed is represented by Aᵢₙ in Formula (1). The diameter of fuel rod 12-1 is determined so as to satisfy Formula (1).

The inventors of the present invention assumed the fuel assembly using the fuel rod 11, the fuel rod 12, and the fuel rod 12-1 in the fuel assembly 13A of the present example illustrated in FIG. 6.

In the cross section of the fuel assembly 13A, the fuel rods 11, 12, and 12-1 are disposed as point-symmetric about the center axis of the fuel assembly 13A.

In the present example, each of the effects generated in Example 1 can be obtained. That is, it is possible to suppress the coolant from being unevenly distributed from the outermost layer and the outer layer portion of the fuel assembly 13A to the inner layer portion in which the fuel rod 12 is disposed.

Further, in the present example, the fuel rod 12-1 having a fuel rod diameter satisfying Formula (1) is disposed on the fuel rod in the inner layer portion, with the fuel rod 12 disposed in the third row from the inner surface of the channel box 17, of the fuel rod disposition in the cross section of the fuel assembly 13A, as a starting point. As a result, in the cross section of the fuel assembly 13A, it is possible to suppress the coolant from being unevenly distributed from the region in which the fuel rod 12 is disposed to the region in which the fuel rod 12-1 is disposed.

Further, in the present example, the fuel rod 12-1 is disposed in the region in which the fuel rod 12 is disposed in Example 1. The fuel rod 12-1 is a fuel rod having a larger diameter than the fuel rod 12, and thus the ratio of the cross-sectional area of the cladding to the cross-sectional area of the fuel rod decreases, it is possible to increase the flow path area while maintaining the fuel volume. Therefore, in the present example, the flow path area can be expected to be increased as compared with Example 1, and thus the effect of further reducing the pressure loss can be expected as compared with Example 1.

The present invention is not limited to the above-described embodiments and examples, and includes various modifications. For example, each of the embodiments and examples described above is described in detail in order to describe the present invention in an easy-to-understand manner, and is not necessarily limited to those having all the described configurations.

What is claimed is:

1. A fuel assembly comprising:
a channel box that is a square cylinder having a square cross section, and a plurality of fuel rods disposed in a square lattice shape in the channel box, and filled with a nuclear fuel material inside,
the plurality of fuel rods including:
a first fuel rod disposed in an outer layer portion in the channel box; and
a second fuel rod that is disposed in an inner layer portion in the channel box and has a diameter larger than the first fuel rod, wherein
an absolute value of a difference between a hydraulic equivalent diameter around the first fuel rod and a hydraulic equivalent diameter between a wall surface in the channel box and the first fuel rod is more than or equal to a value obtained by multiplying an absolute value of a difference between the hydraulic equivalent diameter around the first fuel rod and a hydraulic equivalent diameter around the second fuel rod by a ratio of a cross-sectional area of the inner layer portion of the channel box to a cross-sectional area of the entire channel box.

2. The fuel assembly according to claim 1, wherein a volume of a nuclear fuel material disposed in the fuel assembly is equal to or larger than a volume of a nuclear fuel material when the first fuel rods are disposed in a square lattice shape in the channel box.

3. The fuel assembly according to claim 1, wherein a third fuel rod having a larger diameter than the second fuel rod is disposed in a further inner layer of a region in which the second fuel rod is disposed, and an absolute value of a difference between a hydraulic equivalent diameter around the second fuel rod and a hydraulic equivalent diameter between the first fuel rod and the second fuel rod is more than or equal to a value obtained by multiplying an absolute value of a difference between a hydraulic equivalent diameter around the third fuel rod and a hydraulic equivalent diameter around the second fuel rod by a ratio of a flow path area of a region in which the third fuel rod is disposed to a flow path area of a region in which the second fuel rod and the third fuel rod are disposed.

4. The fuel assembly according to claim 1, wherein the first fuel rods are disposed in 12 rows and 12 columns in the channel box.

5. The fuel assembly according to claim 1, wherein a lower end portion is supported by a lower fuel support member, an upper end portion is supported by an upper fuel support member, a fuel spacer that bundles the plurality of fuel rods is held, and a support rod without containing a fuel material is disposed at each of four corners of an outermost peripheral region of a fuel rod disposition in a cross section of the fuel assembly.

6. A nuclear reactor core, wherein a plurality of the fuel assemblies according to claim 1 are loaded.
